(19) United States
(12) Patent Application Publication
(10) Pub. No.: US 2019/0022941 A1
(43) Pub. Date: Jan. 24, 2019

(54) DIGITAL LIGHT PROCESSING THREE-DIMENSIONAL PRINTING SYSTEM AND METHOD

(71) Applicant: ACKURETTA TECHNOLOGIES PVT. LTD., Taipei (TW)

(72) Inventors: LI-HAN WU, Taipei (TW); AYUSH VARDHAN BAGLA, Taipei (TW)

(21) Appl. No.: 15/656,153

(22) Filed: Jul. 21, 2017

(51) Int. Cl. B29C 64/277; G03B 21/134; G02B 7/02; G02B 7/182; B29C 64/135; B33Y 10/00; B33Y 30/00

(52) U.S. Cl. CPC B29C 64/277; G03B 21/134; G02B 7/023; B33Y 30/00; B29C 64/135; B33Y 10/00; G02B 7/1821

(57) ABSTRACT

A digital light processing (DLP) three-dimensional (3D) printing system includes a container containing a solidifiable material; a platform contacting a portion of the solidifiable material; a projector projecting an electromagnetic radiation on the solidifiable material to form a solidified layer; and an optical component between the projector and the platform; wherein the optical component is rotated to shift the electromagnetic radiation during the formation the solidified layer, thus forming a rounded edge and an enlarged area of the solidified layer. A digital light processing (DLP) three-dimensional (3D) printing method is also disclosed.

### BACKGROUND

### 1. Field

The present disclosure is directed to 3D printing. More particularly, the present disclosure is directed to a digital light processing (DLP) three-dimensional (3D) printing system and method.

### 2. Background

3D (three-dimensional) printing is an effective technology for accurately forming 3D objects for the purpose of prototyping and manufacture. One commercially available 3D printing methodology is stereolithography. Stereolithography aims to create 3D objects based on the successive formation of layers by a fluid-like medium adjacent to previously formed layers of medium and the selective solidification of those layers according to cross-sectional data representing successive slices of the desired three-dimensional object. A stereolithography-based system solidifying fluid medium may include a DLP (Digital Light Processing) projector. The DLP projector typically includes a digital micromirror device (DMD). The DMD has a finite number of pixels, therefore the electromagnetic radiation generated by the DMD is pixelated. The pixelated electromagnetic radiation is applied on the solidifiable material. The pixelated electromagnetic radiation forms pixels on the edge of each of the solidified layer, as illustrated in FIG. 1 and FIG. 2.

The product of DLP is formed from multiple solidified layers, therefore the pixels on each layers are accumulated and transforms to the volume-pixel. The volume-pixel, or voxel, is 3D structure formed by layers of pixels on the solidified layer. The voxels on the edge of DLP products may result in rough or uneven surfaces on the product of DLP.

Referring to FIG. 3, a DLP system of 3D printing includes a platform, a vat and a DLP projector. The DLP projector is located above the platform and the vat. The DLP projector projects UV (Ultra Violet) to a photopolymer resin contained in the vat. The photopolymer resin will be solidified when being applied to UV. At least one part of the platform is positioned inside the vat and in contact with the photopolymer resin. The platform moves vertically after the UV is projected to the photopolymer resin on the platform so the photopolymer on the platform can be re-positioned. Then, the DLP projector will apply UV to a new layer of non-solidified photopolymer resin. Multiple solidified layers of photopolymer resin form a 3D printing product. The 3D printing product can be removed from the platform after the 3D printing process is completed.

The DLP projector can be located under the platform, as illustrated in FIG. 4. The DLP projector projects UV to the photopolymer resin under the platform, and the photopolymer resin under the platform is solidified. The platform moves upward after a solidified layer of the photopolymer resin is formed to expose a new layer of non-solidified photopolymer resin.

Nevertheless, the DMD of the DLP projector has limited pixels. These pixels of the DLP projector lead to pixelated edges of the solidified layer. The DLP product is composed of many solidified layers, therefore the pixels of each layer would be accumulated to form voxels. Low-resolution voxels are the cause of roughness on the surface of the DLP product.

To improve the roughness of conventional DLP products, the surface of the DLP product may be manually polished to remove rough edges and to form smooth appearances. However, the manual polishing process can be costly and time-consuming.

U.S. Pat. No. 7,790,093 disclosed a process improving the resolution of the DLP product, wherein a mirror is rotated along the Y-axis or the X-axis to shift the position of electromagnetic radiation projected on the photopolymer resin, thus adjusting the area being applied to the electromagnetic radiation. After that, the surface of the DLP product is needed to be polished to remove rough edges formed from voxels. Further improvements on forming the DLP products are desired.

### SUMMARY

The present disclosure provides a DLP 3D printing system and method.

The present disclosure is directed to improvements on DLP technology in 3D printing. More particularly, the present disclosure is directed to a DLP 3D printing system and a DLP 3D printing method to improve the quality of stereolithography products.

The present disclosure is further directed to a method for forming one or more enlarged areas or rounded edges of the solidified layer in a DLP 3D printing system.

The present disclosure is further directed to a DLP 3D printing system with at least one optical component. The optical component is a mirror, a lens, or a combination thereof.

### BRIEF DESCRIPTION OF THE DRAWINGS

The present disclosure is illustrated by way of exemplary embodiments and accompanying drawings.

FIG. 1 illustrates an arrangement of pixels of DMD in a conventional DLP projector.

FIG. 2 illustrates another arrangement of pixels of DMD in a conventional DLP projector.

FIG. 3 illustrates a conventional DLP system, wherein the DLP projector is located above the platform.

FIG. 4 illustrates a conventional DLP system, wherein the DLP projector is located under the platform.

FIG. 5A illustrates a DLP system with the projector under the vat according to an exemplary embodiment of the present disclosure.

FIG. 5B illustrates a DLP system with the projector above the vat according to an exemplary embodiment of the present disclosure.

FIG. 6 illustrates an electromagnetic radiation projection of rounded edges and enlarged area according to an exemplary embodiment of the present disclosure.

FIG. 7 illustrates a shifting route of a DLP projector according to an exemplary embodiment of the present disclosure.

FIG. 8 illustrates a circular shifting route and the diameter of the circular shifting route of a DLP projector according to an exemplary embodiment of the present disclosure.

FIG. 9A illustrates an original electromagnetic radiation projection of 5 pixels according to an exemplary embodiment of the present disclosure.

FIG. 9B illustrates an improved electromagnetic radiation projection having a circular shifting diameter of ½ pixel, and the improved electromagnetic radiation projection has enlarged areas when comparing with FIG. 9A.

FIG. 9C illustrates an improved electromagnetic radiation projection having a circular shifting diameter of 1 pixel, and the improved electromagnetic radiation projection has enlarged areas of the projection when comparing with FIG. 9A.

FIG. 10A illustrates a DLP system with lens positioned above a projector and under a vat according to an exemplary embodiment of the present disclosure.

FIG. 10B illustrates the process of forming an enlarged area of an electromagnetic radiation projection according to FIG. 10A.

FIG. 10C illustrates a DLP system with lens positioned under a projector and above a vat according to an exemplary embodiment of the present disclosure.

FIG. 11A illustrates the DLP system with mirror positioned in parallel with a projector and under a vat according to an exemplary embodiment of the present disclosure.

FIG. 11B illustrates the process of forming an enlarged area of the electromagnetic radiation projection according to FIG. 11A.

FIG. 11C illustrates the DLP system with mirror positioned in parallel with a projector and above a vat according to an exemplary embodiment of the present disclosure.

FIG. 12 illustrates a DLP 3D printing method according to an exemplary embodiment of the present disclosure.

### DETAILED DESCRIPTION

The following description provides exemplary embodiments with specific details to one skilled in the art for a better understanding of the present disclosure. However, it should be understood that the present disclosure could be practiced even without these details. In some exemplary embodiments, to avoid unnecessarily obscuring the descriptions of exemplary embodiments, well-known structures and functions are not illustrated or not described in detail. In the specification and claims of the present disclosure, terms such as “including” and “comprising” should be comprehended as an inclusive meaning instead of an exclusive or exhaustive meaning, i.e., it means “including but not limited to” unless specifically described otherwise in the context. In this detailed description section, singular or plural terms include both the plural and singular meanings as well.

A digital light processing (DLP) three-dimensional (3D) printing system is provided, the system comprising: a container containing a solidifiable material; a platform contacting a portion of the solidifiable material; and a projector projecting an electromagnetic radiation on the solidifiable material to form a solidified layer; wherein at least one of the platform and the projector are movable along a predetermined path to shift the electromagnetic radiation during the formation the solidified layer, thus forming a rounded edge and an enlarged area of the solidified layer.

In an exemplary embodiment, the platform is above the projector, and the platform moves upward after the solidified layer is formed in the container.

In an exemplary embodiment, the platform is under the projector, and the platform moves downward after the solidified layer is formed in the container.

In an exemplary embodiment, the predetermined path is circular shifting route, and the circular shifting route is having a shifting diameter.

In an exemplary embodiment, the shifting diameter of the circular shifting route is less than or equal to 10 pixels.

A digital light processing (DLP) three-dimensional (3D) printing system is also provided, the system comprising: a container containing a solidifiable material; a platform contacting a portion of the solidifable material; a projector projecting an electromagnetic radiation on the solidifiable material to form a solidified layer; and an optical component between the projector and the platform; wherein the optical component is rotated to shift the electromagnetic radiation during the formation of the solidified layer, thus forming a rounded edge and an enlarged area of the solidified layer.

In an exemplary embodiment, the optical component is above the projector if the projector is under the container.

In an exemplary embodiment, the optical component is under the projector if the projector is above the container.

In an exemplary embodiment, the optical component is on a same plane with the projector.

In an exemplary embodiment, the optical component is a lens, a mirror or a combination thereof.

In an exemplary embodiment, the lens is a converging lens, a plane lens, a diverging lens or a combination thereof.

In an exemplary embodiment, the lens is rotated around a rotation axis, and the lens is tilted to refract the electromagnetic radiation from the projector; and a tilt angle of the lens is an angle between a normal line of the refraction and the rotation axis.

In an exemplary embodiment, the rotation of the lens is activated by a motor coupled to the lens.

In an exemplary embodiment, the mirror is rotated around a rotation axis, and the mirror is tilted; and a tilt angle of the mirror is an angle between the rotation axis and a normal line of a surface of the mirror.

In an exemplary embodiment, the rotation of the mirror is activated by a motor coupled to the mirror.

In an exemplary embodiment, the combination of the lens and the mirror comprises at least one mirror and at least one lens; the mirror reflects the electromagnetic radiation and the electromagnetic radiation reflected by the mirror is then refracted by the lens; the mirror or the lens is rotated around a rotation axis, and the mirror or the lens is tilted from the rotation axis.

In an exemplary embodiment, the combination of the lens and the mirror comprises at least one mirror and at least one lens; the lens refracts the electromagnetic radiation, and the electromagnetic radiation refracted by the lens is then reflected by the mirror; the mirror or the lens is rotated around a rotation axis, and the mirror or the lens is tilted from the rotation axis.

A digital light processing (DLP) three-dimensional (3D) printing method is also provided, the method comprising: projecting an electromagnetic radiation from the projector on a solidifiable material contained in a container, wherein the solidifiable material is supported by a platform; and modifying the electromagnetic radiation to form a rounded edge of the solidified layer or an enlarged area of the solidified layer when forming a solidified layer from the solidifiable material through the electromagnetic radiation.

In an exemplary embodiment, modifying the electromagnetic radiation to form the rounded edge or the enlarged area is accomplished by tilting or rotating of a lens, a mirror or combination thereof, which is positioned between the projector and the platform.

In an exemplary embodiment, modifying the electromagnetic radiation to form the rounded edge or the enlarged area is accomplished by movement of the projector along a predetermined path.

In an exemplary embodiment, modifying the electromagnetic radiation to form the rounded edge and the enlarged area is accomplished by movement of the platform along a predetermined path.

In an exemplary embodiment, the predetermined path is on the X-Y plane.

In an exemplary embodiment, the predetermined path is a circular shifting route, and the predetermined path is having a shifting diameter.

In an exemplary embodiment, a shifting diameter of the circular shifting route is less than or equal to 10 pixels.

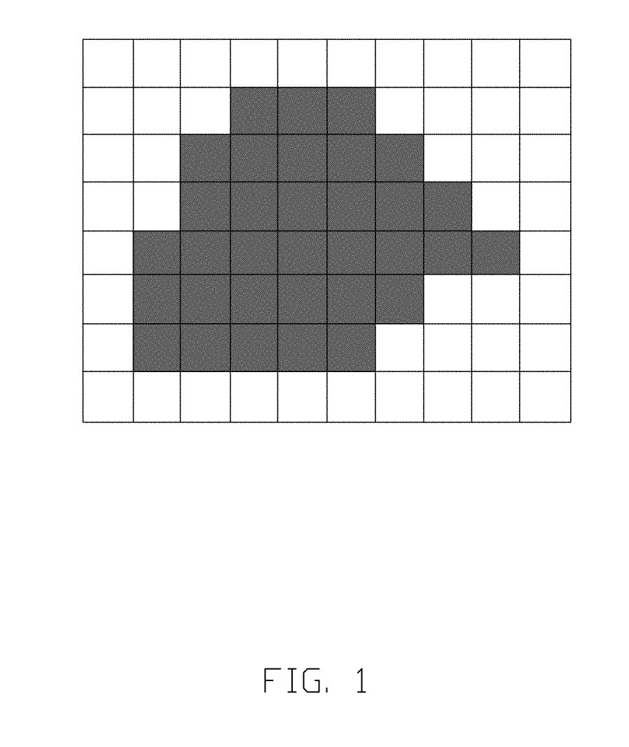

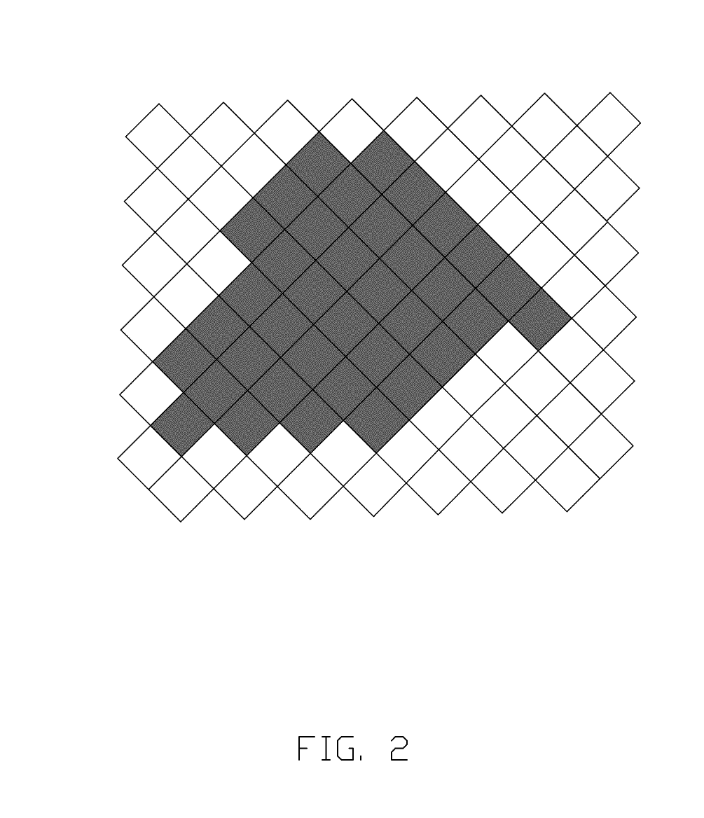

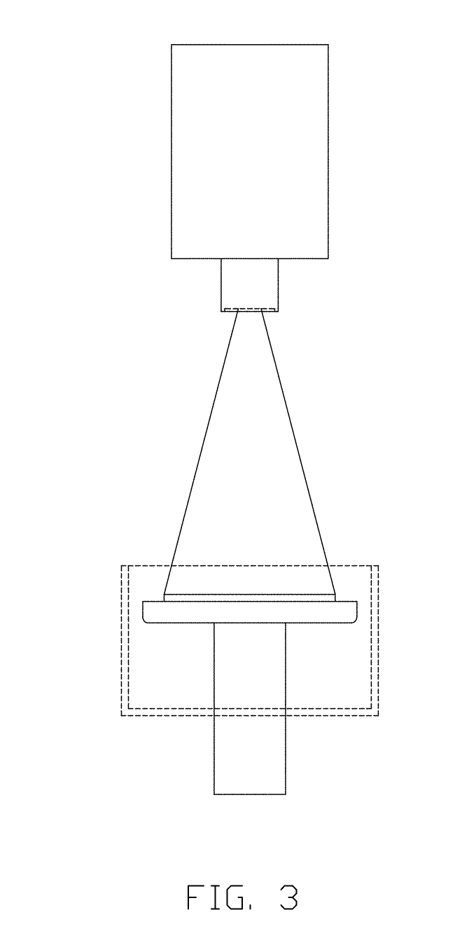

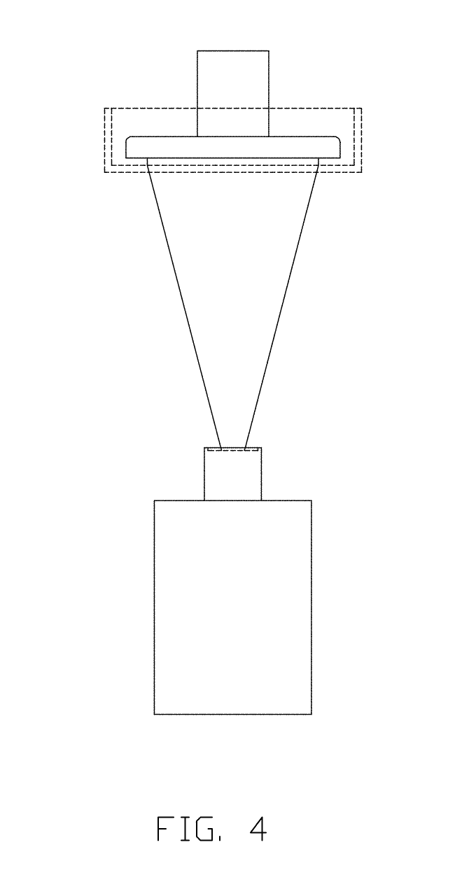

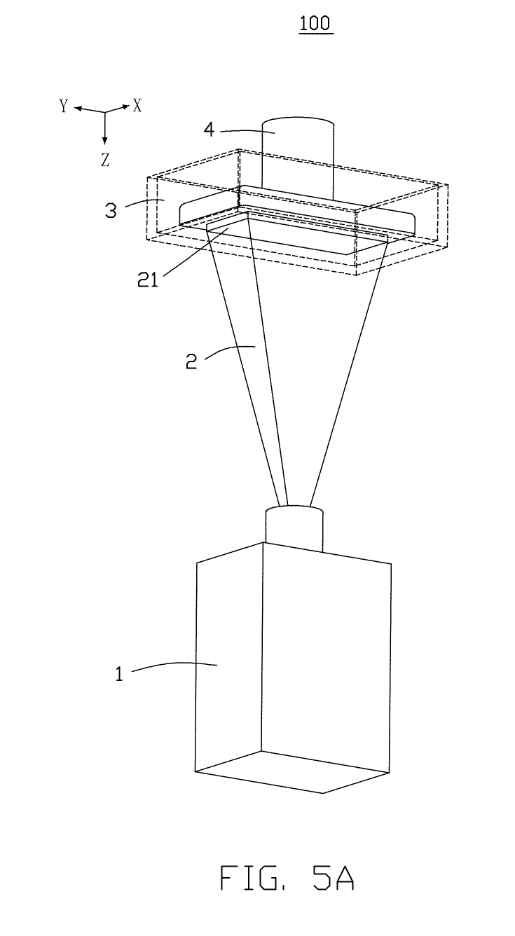

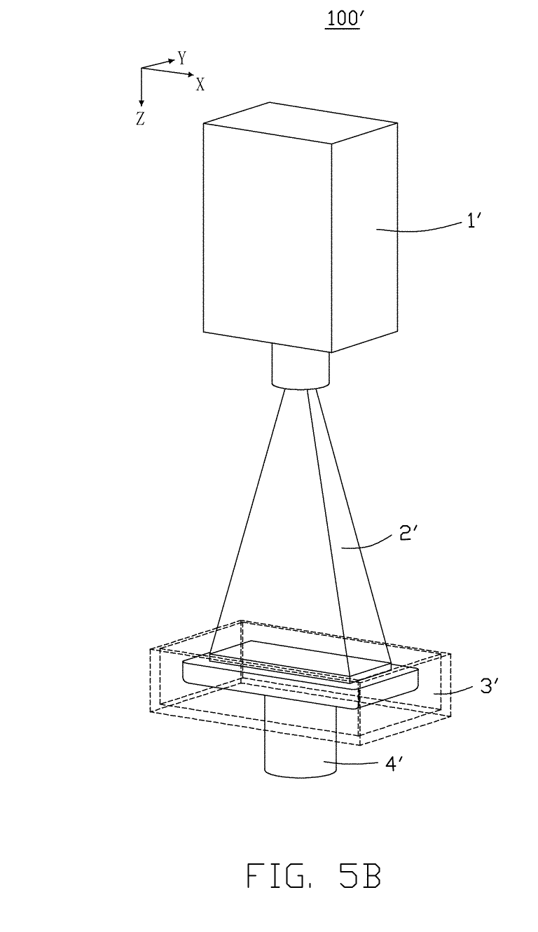

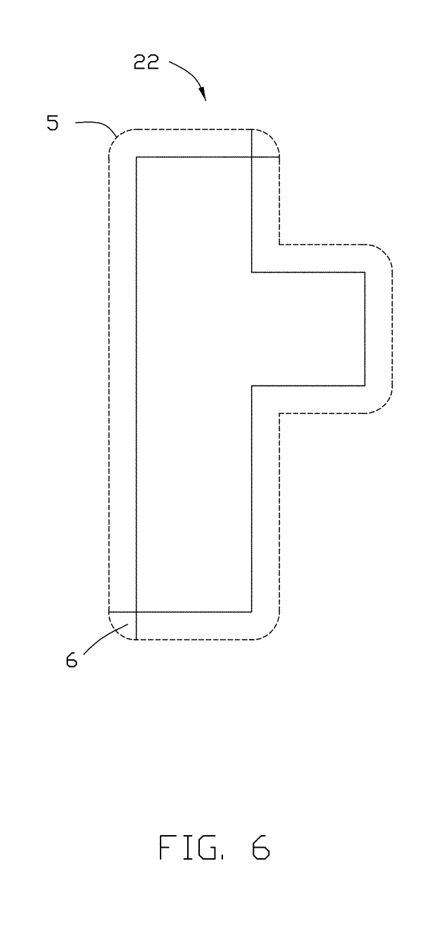

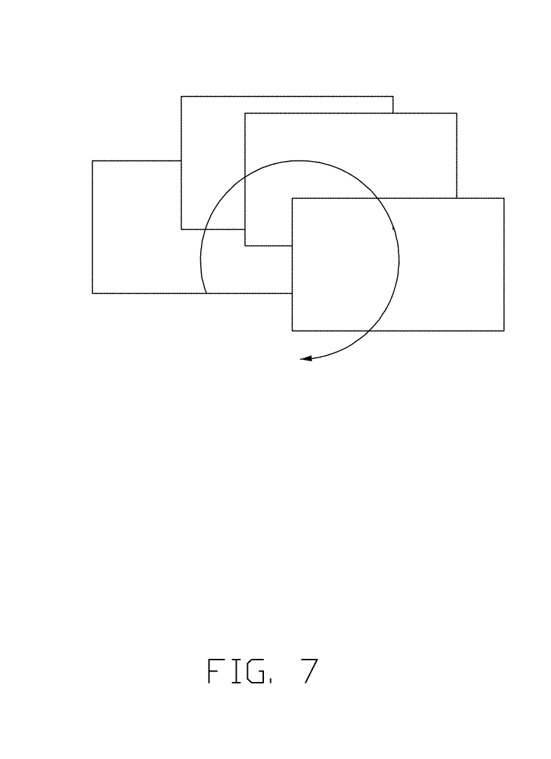

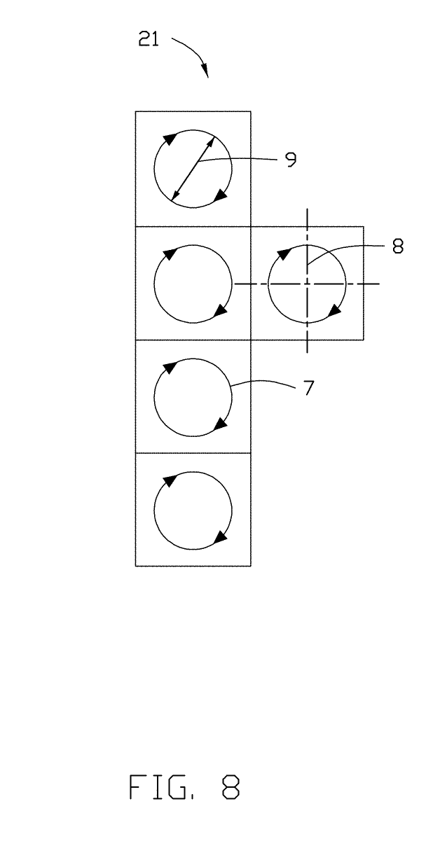

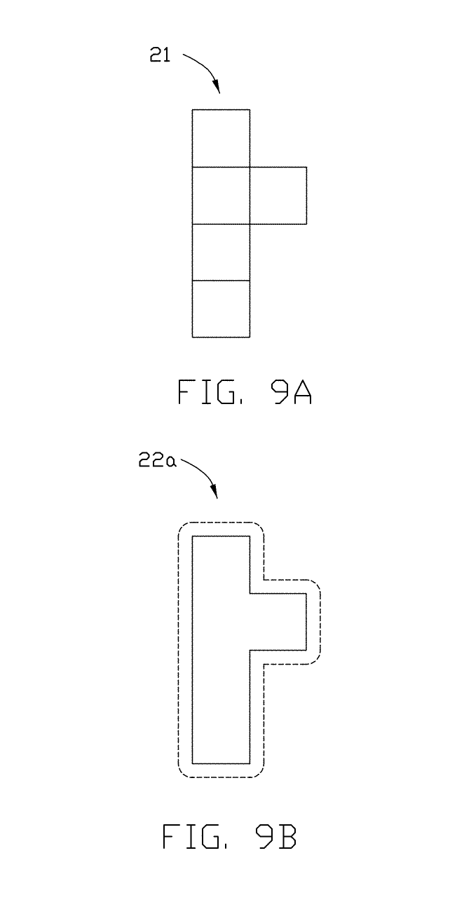

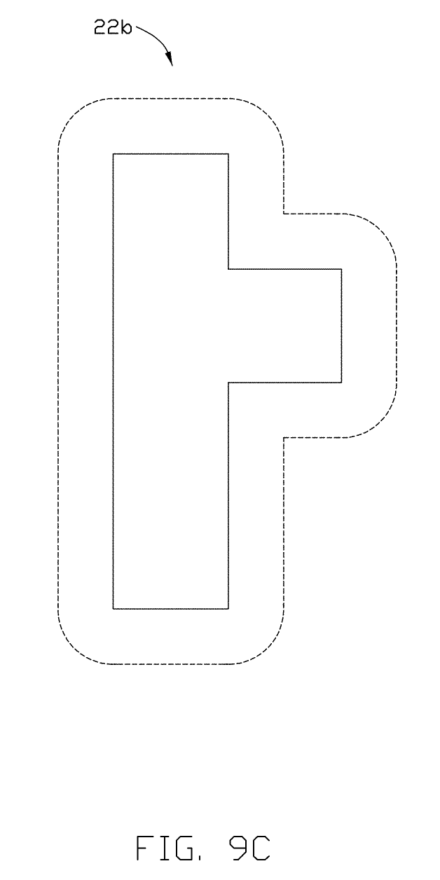

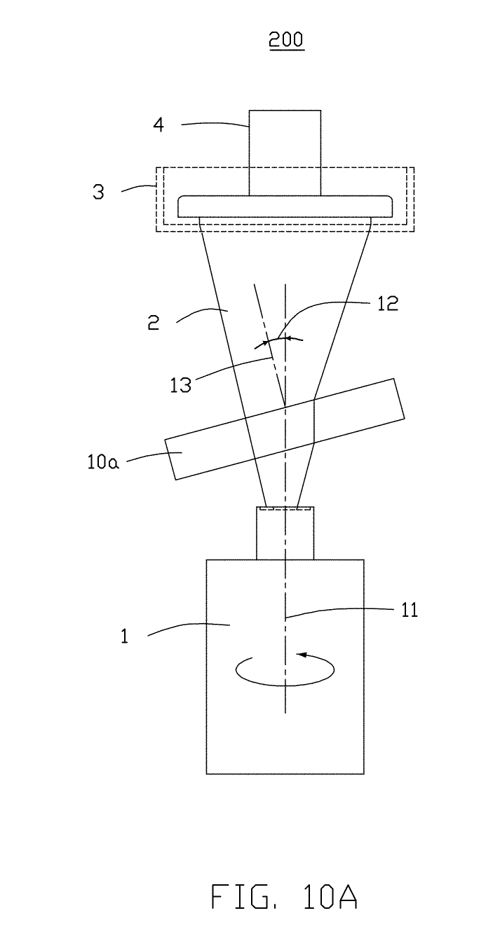

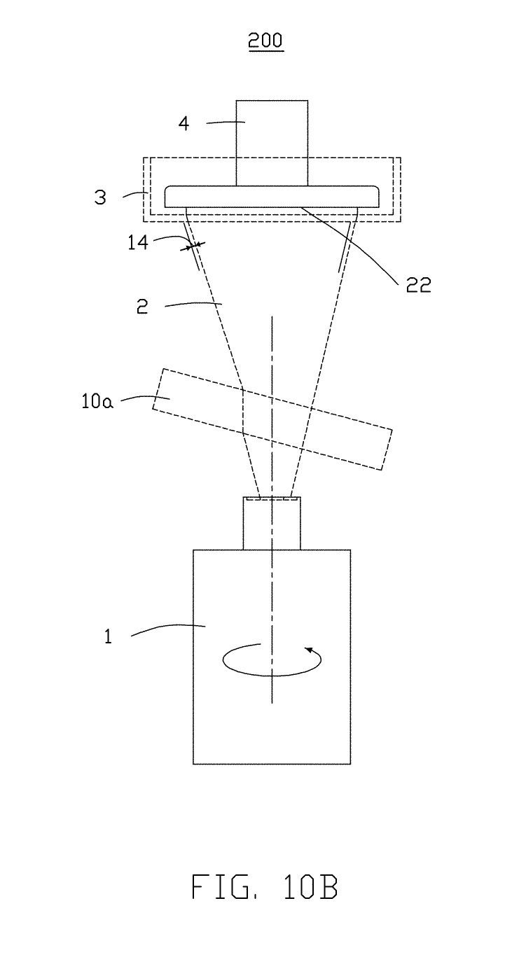

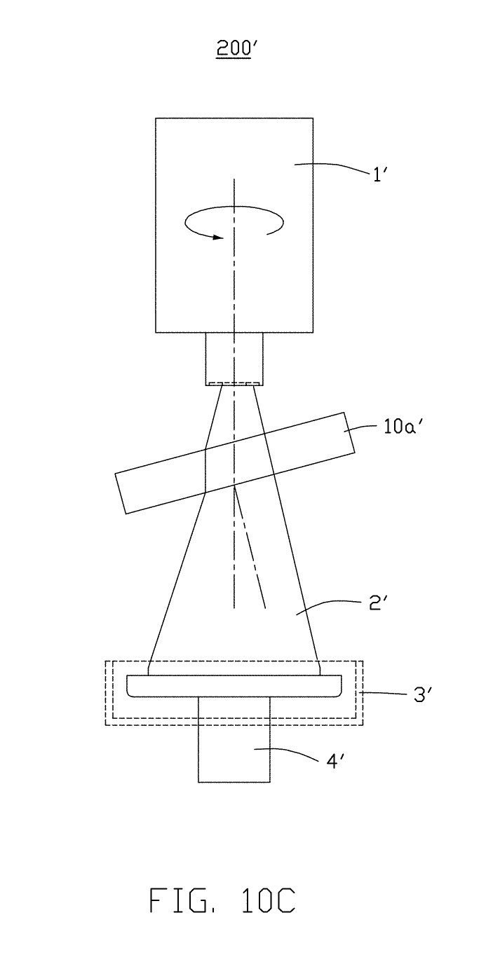

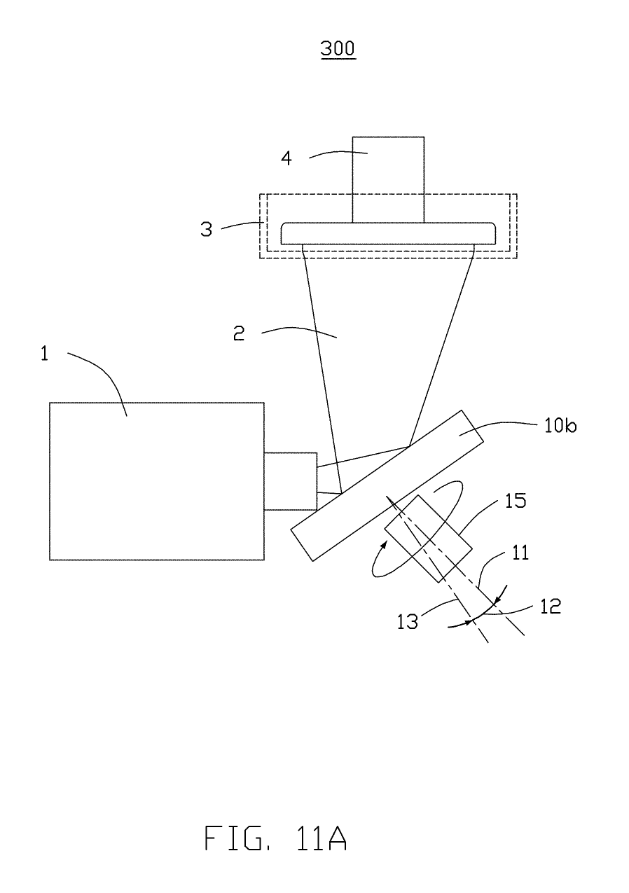

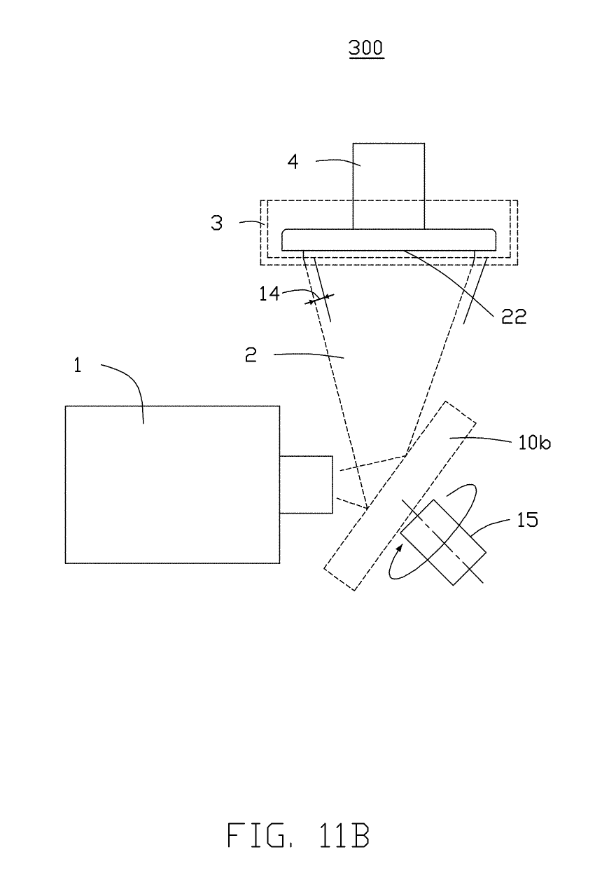

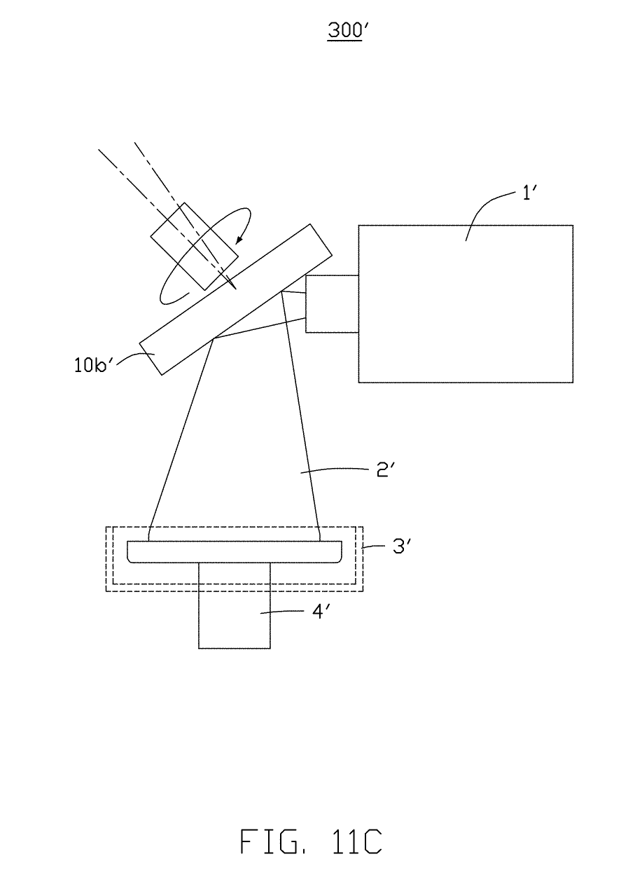

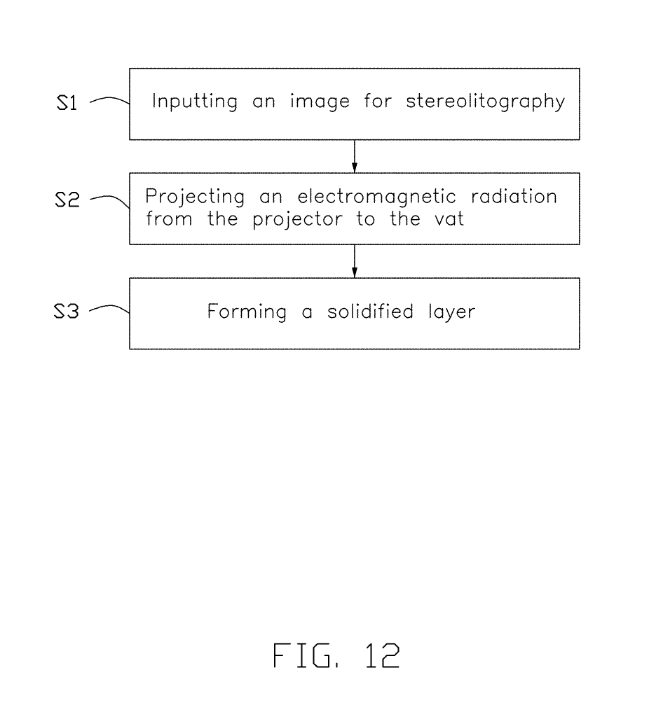

The term “X axis” refers to a direction runs horizontally in FIG. 1 to FIG. 4, and FIG. 6 to FIG. 11C in exemplary embodiments of the present disclosure. The term “Y axis” refers to a direction runs vertically in FIG. 1, FIG. 2, FIG. 6, FIG. 7, FIG. 8, and FIG. 9A to FIG. 9C in exemplary embodiments of the present disclosure. “Y axis” also refers to a direction runs into or out of the page plane in FIG. 3, FIG. 4, FIG. 10A to FIG. 10C, and FIG. 11A to FIG. 11C in exemplary embodiments of the present disclosure. The term “Z axis” refers to a direction runs vertically in FIG. 3, FIG. 4, FIG. 10A to FIG. 10C, and FIG. 11A to FIG. 11C in exemplary embodiments of the present disclosure. The “X-Y plane” refers to a plane formed by X axis and Y axis, wherein FIG. 1, FIG. 2, FIG. 6 to FIG. 8, and FIG. 9A to FIG. 9C are illustrations of exemplary embodiments on the X-Y plane, in accordance with the present disclosure. The “X-Z plane” refers to a plane formed by X axis and Z axis, wherein FIG. 3, FIG. 4, FIG. 10A to FIG. 10C, and FIG. 11A to FIG. 11C are illustrations of exemplary embodiments on the X-Z plane, in accordance with the present disclosure. The X axis, the Y axis and the Z axis in FIG. 5A and FIG. 5B are defined in the figures, respectively.

Referring to FIG. 5A, 5B and FIG. 6, a DLP 3D printing system 100, a DLP 3D printing system 100′ and a DLP 3D printing method in accordance with exemplary embodiments of the present disclosure are provided. As shown in FIG. 5A, the system 100 includes a projector 1 which generates an electromagnetic radiation 2. That is, the projector 1 is a source of the electromagnetic radiation 2. The system 100 may also include a container 3 to contain a solidifiable material, and the solidifiable material forms a solidified layer when exposed to the electromagnetic radiation 2 generated by the projector 1. The electromagnetic radiation 2 forms an electromagnetic radiation projection 21 on the surface of the solidifiable material. The container 3, for example, is a vat 3. The system 100 may further include a platform 4. At least one part of the platform 4 is inside the vat 3 and in contact with a portion of the solidifiable material. The portion of the solidifiable material becomes a solidified layer after being applied to the electromagnetic radiation 2. The platform 4 moves upward after a solidified layer is formed, and the newly formed solidified layer is carried by the platform 4. After the movement of the platform 4, another portion of the solidifiable material under the newly formed solidified layer will be ready to receive the electromagnetic radiation 2. Referring to FIG. 5A, the projector 1 is configured to be under the vat 3, the platform 4 would be above the vat 3, and the platform 4 moves upward after the solidified layer is formed.

Referring to FIG. 5B, a DLP 3D printing system 100′ in accordance with exemplary embodiments of the present disclosure is provided. The projector 1′ is configured to be above the vat 3′. At least one part of the platform 4′ is inside the vat 3′ and in contact with a portion of the solidifiable material. The portion of the solidifiable material becomes a solidified layer after being applied to the electromagnetic radiation 2′.

The platform 4′ moves downward after the solidified layer is formed, and the newly formed solidified layer is carried by the platform 4′. After the movement of the platform 4′, another portion of the solidifiable material above the newly formed solidified layer will be ready to receive the electromagnetic radiation 2′.

The projector 1 or platform 4 may be movable along a predetermined path to shift the electromagnetic radiation 2 during the formation of the solidified layer, thus forming an electromagnetic radiation projection 22 with rounded edges 5 or enlarged areas 6, as shown in FIG. 6. The predetermined path may be on the X-Y plane. In an exemplary embodiment, an actuator (not shown) may be coupled to the projector 1 or the platform 4 to facilitate the movement of the projector 1 or the platform 4. The actuator can be a motor mechanism, and the motor mechanism is predetermined in the DLP 3D printing system. The solidifiable material will form a solidified layer by the shape of electromagnetic radiation projection 22 in FIG. 6.

When the projector 1′ is configured to be above the vat 3′, the platform 4′ moves downward after the solidified layer is formed in the vat 3′. When the projector 1 is configured to be under the vat 3, the platform 4 would be above the vat 3, and the platform 4 moves upward after the solidified layer is formed in the vat 3. The platform (4, 4′) may be shifted in a plane relative to the projector (1, 1′) to form electromagnetic radiation projections 22 of rounded edges and enlarged area. The platform (4, 4′) may be shifted in the X-Y plane.

The DLP 3D printing system 100 may generate multiple electromagnetic radiation projections of rounded edges and enlarged areas. A solidification process is the formation of a solidified layer when being applied to an electromagnetic radiation projection 21. In an exemplary embodiment of the present disclosure, the solidifiable material can be a photopolymer resin. A solidified layer is formed when being applied to the electromagnetic radiation projection 21. The shape of the solidified layer corresponds to the shape of the electromagnetic radiation projection 21.

The projector 1 includes a DMD. The DMD is the source of electromagnetic radiation 2 and generates at least one wavelength of electromagnetic radiation 2. The wavelength of the electromagnetic radiation 2 is dependent on the solidifiable material used in the DLP 3D printing system 100. The electromagnetic radiation 2 has a range of wavelength of about 350 nm to 550 nm. Preferably, the wavelength of the electromagnetic radiation 2 is about 405 nm. The electromagnetic radiation 2 can be UV. One or more original images are inputted into the projector 1 to be processed into an electromagnetic radiation projection. At least one of the platform 4 and the projector 1 is movable along a predetermined path, and the electromagnetic radiation is projected to the solidifiable material, thus forming rounded edges 5 of the solidified layer and enlarged areas 6 of the solidified layer. As illustrated in FIG. 7, the projector 1 may be shifted relative to the vat to form electromagnetic radiation projections 21 of rounded edges and enlarged area. As illustrated in FIG. 8, the shifting route 7, i.e., the predetermined path, may be a circular shifting route. The circular shifting route 7 moves around a center 8, and the circular shifting route 7 has a diameter 9 relative to the center 8. The circular shifting route 7 may be on the X-Y plane. As illustrated in FIG. 9A, there are 5 pixels in the original electromagnetic radiation projection 21. However, as illustrated in FIG. 9B, the area of the electromagnetic radiation projection 22a is enlarged comparing to the original image. The circular shifting diameter is positively correlated to the enlarged area of the electromagnetic radiation projection 22a; and the larger the circular shifting diameter, the larger the enlarged area. The circular shifting diameter is less than 10 pixels. The circular shifting diameter may include, but not be limited to ½ pixel as shown as FIG. 9B, or 1 pixel as shown as FIG. 9C. The circular shifting diameter can be an integer multiple of one pixel, such as 1, 2, 3, 4, 5, 6, 7 or 8 pixels. The circular shifting diameter can also be a non-integer multiple of one pixel, such as 0.5, 1.11, 2.11 or 3.33 pixels.

The vat 3 is comprised of one or more transparent materials. The electromagnetic radiation 2 from the projector 1 is able to pass through the transparent material of the vat 3 and reach the solidifiable material contained in the vat.

In an exemplary embodiment, the system may include an optical component between the source of electromagnetic radiation 1 and the platform 4. The optical component can be a lens 10a, a mirror 10b or a lens/mirror combination. The optical component may be tilted and rotated to direct the electromagnetic radiation 2 to form a rounded contour on the edge of the projection.

The optical component is positioned between the source of the electromagnetic radiation 2 and the vat 3. The arrangement of the optical component in the DLP 3D printing system is dependent on the position of the projector 1 and the vat 3. The optical component can be above the projector 1 if the projector 1 is under the vat 3. The optical component 10 can also be under the projector 1 if the projector 1 is above the vat 3. The optical component 10 can also be located on the same plane with the projector 1. The optical component may change the route of the electromagnetic radiation 2 from the projector 1, and may change the shape of the electromagnetic radiation projection 21 on the solidifiable material. The optical component can be any one of a lens, a mirror or a lens/mirror combination.

A DLP 3D printing system 200 in accordance with exemplary embodiments of the present disclosure is provided. The optical component is the lens 10a as shown in FIG. 10A. The lens 10a can be a converging lens, a plane lens, a diverging lens or a combination thereof. Referring to FIG. 10A, the projector 1 is under the vat 3, and the lens 10a is positioned above the projector 1 and located between the projector 1 and the vat 3. Referring to FIG. 10A, the lens 10a is rotated around a rotation axis 11, and the lens 10a is tilted to refract the electromagnetic radiation 2 from the projector 1. The electromagnetic radiation 2 is refracted by the lens 10a, and the tilt angle 12 of the lens 10a is the angle between the normal line 13 of the surface of the lens 10a and the rotation axis 11. The tilted rotating lens 10a may enlarge the electromagnetic radiation projection 22 as shown as FIG. 10B. The tilt angle 12 of the lens 10a is positively correlated to the enlarged area 14 of the electromagnetic radiation. The tilt angle 12 may be predetermined or programmed in the DLP 3D printing system 200 of the present disclosure, in accordance with the size of the enlarged area. The tilt angle 12 can be affected by material and optical properties of the lens 10a. When setting the tilt angle 12, the refractive index (RI), the thickness or the focus of the lens 10a may be determinants of the tilt angle 12. The tilt angle 12 can be 1° to 45°. Preferably, the tile angle 12 can be 5°.

Referring to FIG. 10C, a DLP 3D printing system 200′ in accordance with exemplary embodiments of the present disclosure is provided. The projector 1′ is above the vat 3′, the lens 10a′ is positioned under the projector 1′ and located between the projector 1′ and the vat 3′ in the DLP 3D printing system 100′ in an exemplary embodiment. The lens 10a′ is tilted to refract the electromagnetic radiation 2′ from the projector 1′.

A DLP 3D printing system 300 in accordance with exemplary embodiments of the present disclosure is provided. The optical component 10 is the mirror 10b as shown as FIG. 11A. The projector 1 is under the vat 3, the mirror 10b can be positioned in parallel with the projector 1 and under the vat 3. The mirror 10b may reflect the electromagnetic radiation 2 generated by the DMD in the projector 1. The mirror 10b is rotated around a rotation axis 11. The rotation is activated by a motor 15 coupled to the mirror 10b. The mirror 10b is tilted, and the tilt angle 12 of the mirror 10b is the angle between the rotation axis and a normal line 13 of the surface of the mirror 10b. When comparing with the original image, the electromagnetic radiation projection 22 is enlarged because of the tilted rotational mirror as shown as FIG. 11B. The tilt angle 12 of the mirror 10b is positively correlated to the enlarged area 14 of the projection. The tilt angle 12 may be predetermined or programmed in the DLP 3D printing system 300 of the present disclosure, in accordance with the size of the enlarged area 14. The tilt angle 12 can be affected by various determinant in the DLP 3D printing system 300 illustrated in FIG. 11A and FIG. 11B. The distance between center of the mirror 10b and the image focus plane, the image rotation shift radius and the focus of the mirror 10b can be determinants when setting the tilt angle 12. Preferably, the tilt angle 12 is less than 1°.

A DLP 3D printing system 300′ in accordance with exemplary embodiments of the present disclosure is provided. Referring to FIG. 11C, the projector 1′ is above the vat 3′, the mirror 10b′ can be positioned in parallel with the projector 1′ and above the vat 3′ in the DLP 3D printing system 300′ in an exemplary embodiment. The mirror 10b′ may reflect the electromagnetic radiation 2′ generated by the DMD in the projector 1′.

In an exemplary embodiment, the optical component is a mirror/lens combination. The mirror/lens combination includes at least one mirror and at least one lens. The mirror/lens combination is positioned between the projector and the vat. The mirror reflects the electromagnetic radiation generated by the DMD in the projector, and the electromagnetic radiation reflected by the mirror is refracted by the lens. The lens can also be positioned to refract the electromagnetic radiation generated by the DMD in the projector, and the electromagnetic radiation refracted by the lens is then reflected by the mirror. The mirror or the lens can be rotated, and the mirror or the lens can be tilted from the rotation axis. Enlarged areas may be present in the electromagnetic radiation projection, and the enlarged areas of the electromagnetic radiation projection are positively correlated to the tilt angle of the mirror or the lens.

In an exemplary embodiment, the DLP system may include at least one lens, a projector, a platform and a vat. One or more lenses are located between the projector and the platform. The lens can be a converging lens, a plane lens, a diverging lens or a combination thereof. If the projector is under the vat, the lens is positioned above the projector and between the projector and the vat. If the projector is above the vat, the lens is positioned under the projector and between the projector and the vat. The electromagnetic radiation generated by the DMD in the projector is refracted by the lens. The refracted electromagnetic radiation forms at least one electromagnetic radiation projection on the solidifiable material in the vat. The lens is rotated around a rotation axis, and the lens is tilted. The rotation of the lens is activated by a motor coupled to the lens. The tilt angle of the lens is the angle between the normal line of the refraction and the rotation axis. The tilted rotating lens may enlarge the electromagnetic radiation projection. The tilt angle of the lens is positively correlated to the enlarged area of the projection.

In an exemplary embodiment, the DLP system may include at least one mirror, a projector, a platform and a vat. One or more mirrors are located in parallel with the electromagnetic radiation source. The mirror reflects the electromagnetic radiation generated by the DMD in the projector. The mirror is rotated around a rotation axis. The rotation is activated by a motor coupled to the mirror. The mirror is tilted, and the tilt angle of the mirror is the angle between the rotation axis and a normal line of the surface of the mirror. The tilted mirror may enlarge the electromagnetic radiation projection. The tilt angle of the mirror is positively correlated to the enlarged area of the projection.

In an exemplary embodiment, the DLP system may include at least one mirror, at least one lens, a projector, a platform and a vat. The electromagnetic radiation generated by the DMD in the projector can be reflected by the mirror and then refracted by the lens to reach the vat. The electromagnetic radiation generated by the DMD in the projector can also be refracted by the lens and then reflected by the mirror to reach the vat. The lens or the mirror can be rotated or tilted to form an electromagnetic radiation projection of rounded edges and enlarged areas relative to the original image. The rotation mechanism is activated by a motor coupled to the lens or the mirror.

In an exemplary embodiment, the DLP system may include a movable projector, a platform and a vat. The projector is movable relative to the platform. The projector is shifted during one solidification process to form electromagnetic radiation projections of rounded edges and enlarged area. The projector can be shifted in a circular manner. The circular shifting moves around a center, and the circular shifting has a diameter relative to the center. At least one circular shifting may be completed in a single solidification process. To ensure the size and detail appearances of the DLP product are not altered dramatically, the circular shifting diameter is less than or equal to 10 pixels.

In an exemplary embodiment, the present disclosure is further directed to an improved stereolithography process, in particular, a DLP 3D printing method. Referring to FIG. 12, the method includes:

S1: inputting an image for stereolitography: the user may input a 3D design of an object to the DLP 3D printing system. The 3D design can be sliced into multiple layers of images manually or automatically. The layers of images may be modified. The projector receives original or modified image of each layer to form one or more electromagnetic radiation projections.

S2: projecting an electromagnetic radiation from the projector to the vat: the electromagnetic radiation is shifted, refracted or reflected to form a rounded contour or enlarged areas relative to the original image on the solidifiable material in the vat. The shifting, refraction or reflection of the electromagnetic radiation may be contributed to the movement of any one or more of the following components in the DLP system, and the movement, tilt and rotation of the components are programmed so that the electromagnetic radiation projections are modifications of the original image.

The tilt angle of the lens, the mirror or the lens/mirror combination corresponds to the enlarged area of the electromagnetic radiation projection.

The shifting of the projector: the projector can be shifted relative to the platform to form the shape of the electromagnetic radiation projection. The shifting route of the projector can be a circular route. The circular shifting route may surround a center. The circular shifting route may have a diameter. Larger circular shifting diameter represents larger enlarged areas.

The shifting of the platform: the platform can be shifted relative to the projector to form the shape of the electromagnetic radiation projection.

S3, forming a solidified layer: the solidified layer is formed from the solidifiable material in the vat. The solidified layer has a shape corresponds to the electromagnetic radiation projection. When comparing with the original image, the shape of the solidified layer has a rounded edge and enlarged areas.

The DLP product in accordance with exemplary embodiments of the present disclosure would have rounded edges. The DLP product would not need to be polished after the product leaves the DLP system, therefore greatly reduces time and cost needed for polishing.

It is to be further understood that even though numerous characteristics and advantages of the present exemplary embodiments have been set forth in the foregoing description, together with details of the structures and functions of the exemplary embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A digital light processing (DLP) three-dimensional (3D) printing system, comprising:
a container containing a solidifiable material;
a platform contacting a portion of the solidifiable material; and
a projector projecting an electromagnetic radiation on the portion of the solidifiable material contacting the platform to form a solidified layer;
wherein at least one of the platform and the projector are movable along a predetermined path to shift the electromagnetic radiation during the formation the solidified layer, thereby forming a rounded edge and an enlarged area of the solidified layer.

2. The system of claim 1, wherein the platform is above the projector, the platform moves upward after the solidified layer is formed in the container.

3. The system of claim 1, wherein the platform is under the projector, the platform moves downward after the solidified layer is formed in the container.

4. The system of claim 1, wherein the predetermined path is on the X-Y plane.

5. The system of claim 1, wherein the predetermined path is a circular shifting route, and the circular shifting route is having a shifting diameter.

6. The system of claim 5, wherein the shifting diameter of the circular shifting route is less than or equal to 10 pixels.

7. A digital light processing (DLP) three-dimensional (3D) printing system, comprising:
a container containing a solidifiable material;
a platform contacting a portion of the solidifiable material;
a projector projecting an electromagnetic radiation on the portion of the solidifiable material contacting the platform to form a solidified layer; and
an optical component between the projector and the platform;
wherein the optical component is rotated to shift the electromagnetic radiation during the formation of the solidified layer, thereby forming a rounded edge and an enlarged area of the solidified layer.

8. The system of claim 7, wherein the optical component is above the projector if the projector is under the container.

9. The system of claim 7, wherein the optical component is under the projector if the projector is above the container.

10. The system of claim 7, wherein the optical component is on a same plane with the projector.

11. The system of claim 7, wherein the optical component is a lens, a mirror or a combination thereof.

12. The system of claim 11, wherein the lens is a converging lens, a plane lens, a diverging lens or a combination thereof.

13. The system of claim 11, wherein the lens is rotated around a rotation axis, and the lens is tilted to refract the electromagnetic radiation from the projector; and a tilt angle of the lens is an angle between a normal line of the refraction and the rotation axis.

14. The system of claim 13, wherein the rotation of the lens is activated by a motor coupled to the lens.

15. The system of claim 11, wherein the mirror is rotated around a rotation axis, and the mirror is tilted; and a tilt angle of the mirror is an angle between the rotation axis and a normal line of a surface of the mirror.

16. The system of claim 15, wherein the rotation of the mirror is activated by a motor coupled to the mirror.

17. The system of claim 11, wherein the combination of the lens and the mirror comprises at least one mirror and at least one lens; the mirror reflects the electromagnetic radiation and the electromagnetic radiation reflected by the mirror is refracted by the lens; the mirror or the lens is rotated around a rotation axis, and the mirror or the lens is tilted from the rotation axis.

18. The system of claim 11, wherein the combination of the lens and the mirror comprises at least one mirror and at least one lens; the lens refracts the electromagnetic radiation, and the electromagnetic radiation refracted by the lens is reflected by the mirror; the mirror or the lens is rotated around a rotation axis, and the mirror or the lens is tilted from the rotation axis.

19. A digital light processing (DLP) three-dimensional (3D) printing method, comprising:
projecting an electromagnetic radiation from a projector on a solidifiable material contained in a container, the platform contacting a portion of the solidifiable material; and
modifying the electromagnetic radiation to form a rounded edge of the solidified layer and an enlarged area of the solidified layer during the formation of a solidified layer from the solidifiable material through the electromagnetic radiation.

20. The method of claim 19, wherein modifying the electromagnetic radiation to form the rounded edge or the enlarged area by tilting or rotating of an optical component, the optical component is positioned between the projector and the platform.

21. The method of claim 20, wherein the optical component is a lens, a mirror or combination thereof.

22. The method of claim 19, wherein modifying the electromagnetic radiation to form the rounded edge or the enlarged area by movement of the projector or the platform along a predetermined path.

23. The method of claim 22, wherein the predetermined path is a circular shifting route, and the predetermined path is having a shifting diameter.

24. The method of claim 23, wherein the shifting diameter of the circular shifting route is less than or equal to 10 pixels.
